(19) United States
(12) Patent Application Publication
(10) Pub. No.: US 2009/0265262 A1
(43) Pub. Date: Oct. 22, 2009

(54) METHOD AND SYSTEM FOR INSTALLMENT PAYMENT UTILIZATION

(75) Inventor: Hardik Chaudhari, San Francisco, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc., San Jose, CA (US)

(21) Appl. No.: 12/107,390

(22) Filed: Apr. 22, 2008

(51) Int. Cl. G06Q 40/00; G06Q 20/00

(52) U.S. Cl. 705/34; 705/40; 705/39

(57) ABSTRACT

Methods and system for installment payment utilization are described. In one embodiment, a revolving balance of a credit instrument associated with a user may be accessed. The revolving balance may be at a revolving balance interest rate. An installment balance may be designated for the credit instrument. The installment balance may be associated with a payment schedule and a payment amount and be at a different interest rate than the revolving balance interest rate. The credit instrument may be updated responsive to the designation of the installment balance.

### BACKGROUND

A user of a credit card may rack up a balance purchasing items that the user is unable to immediately pay off. The balance of the credit card may be reduced as the user continues to make payments. However, the balance of the credit card may be increased of the user purchases additional items.

### BRIEF DESCRIPTION OF THE DRAWINGS

Some embodiments are illustrated by way of example and not limitation in the figures of the accompanying drawings in which:

FIG. 1 is a block diagram of a system, according to example embodiments;

FIGS. 2 and 3 are block diagrams of credit management subsystems that may be deployed within the system of FIG. 1 according to an example embodiment;

FIGS. 4-6 are example flowcharts illustrating a method for credit instrument processing according to example embodiments;

FIGS. 7 and 8 are example flowcharts illustrating a method for payment processing according to example embodiments;

FIG. 9 is an example flowchart illustrating a method for credit card processing according to example embodiments;

FIG. 10 is a network diagram depicting a network system, according to one embodiment, having a client server architecture configured for exchanging data over a network;

FIG. 11 is a block diagram illustrating an example embodiment of multiple network and marketplace applications, which are provided as part of the network-based marketplace; and

FIG. 12 is a block diagram diagrammatic representation of machine in the example form of a computer system within which a set of instructions for causing the machine to perform any one or more of the methodologies discussed herein may be executed.

### DETAILED DESCRIPTION

Example methods and systems for installment payment utilization are described. In the following description, for purposes of explanation, numerous specific details are set forth in order to provide a thorough understanding of example embodiments. It will be evident, however, to one skilled in the art that the present invention may be practiced without these specific details.

In an example embodiment, a revolving balance of a credit instrument associated with a user may be accessed. The revolving balance may be at a revolving balance interest rate. An installment balance may be designated for the credit instrument. The installment balance may be associated with a payment schedule and a payment amount and be at a different interest rate than the revolving balance interest rate. The credit instrument may be updated responsive to the designation of the installment balance.

In an example embodiment, a purchase offer for an item may be received utilizing a credit card. The credit card may be associated with a user. An installment payment setting for the user may be accessed. A payment schedule and a payment amount may be designated for an installment payment plan based on the purchase offer and the installment payment setting. The credit card may be processed with the purchase offer responsive to the designating of the payment schedule and the payment amount.

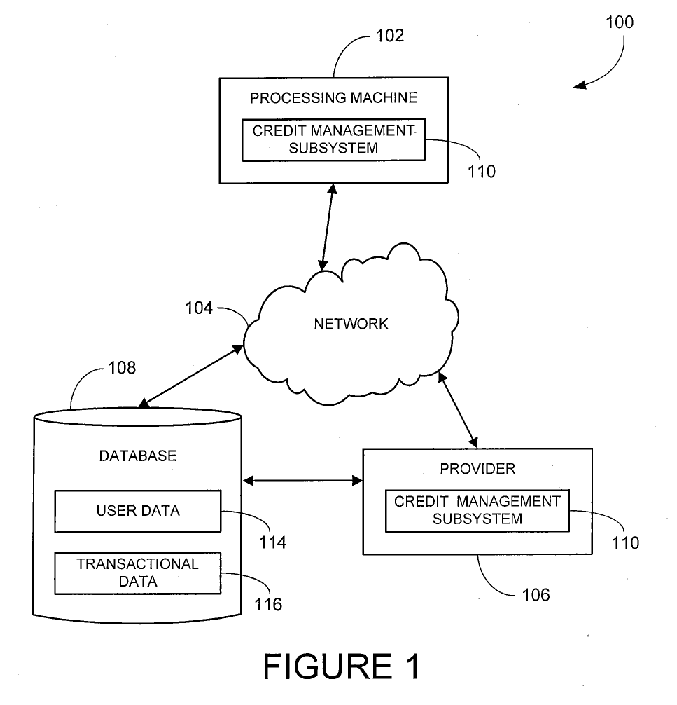

FIG. 1 illustrates an example system 100 in which a processing machine 102 may be in communication with a provider 106 over a network 104. An operator of the processing machine 102 may communicate with the provider 106 to obtain credit for a purchase of an item on behalf of a user. Examples of the processing machine 102 include a banking terminal (e.g., a credit card machine), a set-top box (STB), a receiver card, a mobile telephone, a personal digital assistant (PDA), a display device, a portable gaming unit, and a computing system; however other devices may also be used. The user may operate the processing machine 102, or a merchant may operate the processing machine 102 to facilitate purchase of the item on behalf of the user.

The network 104 over which the processing machine 102 and the provider 106 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The provider 106 may be a provider of a credit instrument (e.g., a credit card). For example, the provider 106 may be, by way of example, PayPal.com. The provider 106 may include a credit management subsystem 110 to process requests for credit. The provider 106 may also be in communication with a database 108. The database 108 may include user data 114 and/or transactional data 116. The user data 114 may include information regarding users of the provider 106. The transactional data 116 may include information regarding transactions conducted by the provider 106. For example, the sale of an item from one user to another may be stored in the transactional data 116.

The credit management subsystem 110 may be deployed within the processing machine 102 to enable the processing of credit on behalf of the user. However, the credit management subsystem 110 need not be deployed in both the processing machine 102 and the provider 106 to process credit.

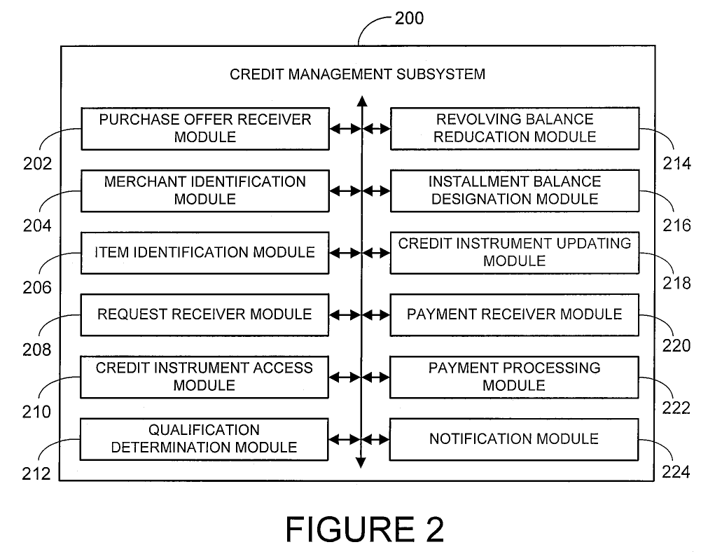

FIG. 2 illustrates an example credit management subsystem 200 that may be deployed in the processing machine 102 and/or the provider 106 of the system 100 as the credit management subsystem 110 (see FIG. 1) or otherwise deployed in another system. The credit management subsystem 200 may include a purchase offer receiver module 202, a merchant identification module 204, an identification receiver module 206, a request receiver module 208, a credit instrument access module 210, a qualification determination module 212, a revolving balance reduction module 214, an installment balance designation module 216, a credit instrument updating module 218, a payment receiver module 220, a payment processing module 222, and/or a notification module 224. Other modules may also be included.

The purchase offer receiver module 202 receives a purchase offer for an item utilizing a credit instrument. The credit instrument may be a credit card or a different type of credit instrument. The merchant identification module 204 receives identification of a merchant associated with the item.

The identification receiver module 206 receives identification of one or more previously purchased items by the user and/or a balance portion. The request receiver module 208 receives a request for an installment payment plan with a payment schedule and/or a payment amount associated with the credit instrument.

The credit instrument access module 210 accesses a credit instrument (e.g. a credit card) with a revolving balance. The credit instrument may be associated with a particular user. The revolving balance of the credit instrument may be at a revolving balance interest rate. The revolving balance interest rate may be a variable interest rate subject to fluctuation. For example, the revolving balance interest rate may adjust based on a promotional interest rate, on adjustment of the prime interest, on receipt of one or more late payments, one or more missed payments, or the like.

The qualification determination module 212 determines whether the user, the purchase offer, and/or the merchant qualify for an installment payment plan with the credit instrument. The revolving balance reduction module 214 reduces the revolving balance by the installment balance. The reduction of the revolving balance may be responsive to the receiving of the identification of a previously purchased item.

The installment balance designation module 216 designates an installment balance for the credit instrument. The installment balance may be associated with a payment schedule and a payment amount. The payment schedule may be a fixed payment schedule or a variable payment schedule. The payment amount may be a fixed payment amount or a variable payment amount. The installment balance may be at a different interest rate than a revolving balance interest rate associated with the credit instrument. The different interest rate may be a fixed interest rate or a variable interest rate. The different interest rate may be a lower or higher interest rate then the revolving balance interest rate. The designation of the installment balance may be based on qualification of the user, the purchase offer, and/or the merchant. The designation of the installment balance may be responsive to the reduction of the revolving balance.

The credit instrument updating module 218 processes the credit instrument responsive to the designation of the installment balance. The update may include updating a balance of the installment payment plan based on payments received. In an example embodiment, a credit limit of the credit instrument may be updated by the credit instrument updating module 218 based on the revolving balance and the installment balance. The payment receiver module 220 receives a payment associated with the user.

The payment processing module 222 processes the payment based on the revolving balance and the installment balance. The processing of the payment may include crediting a payment amount of the payment to the installment balance and crediting a remaining balance amount of the payment to the revolving balance. The processing of the payment may include crediting a minimum balance amount of the payment to the revolving balance, crediting a remaining balance amount of the payment to the installment balance, and penalizing the user of the credit account based on the remaining balance amount being less than the fixed payment amount. The notification module 224 notifies the user of the payment schedule, the payment amount, and/or the installment payment plan.

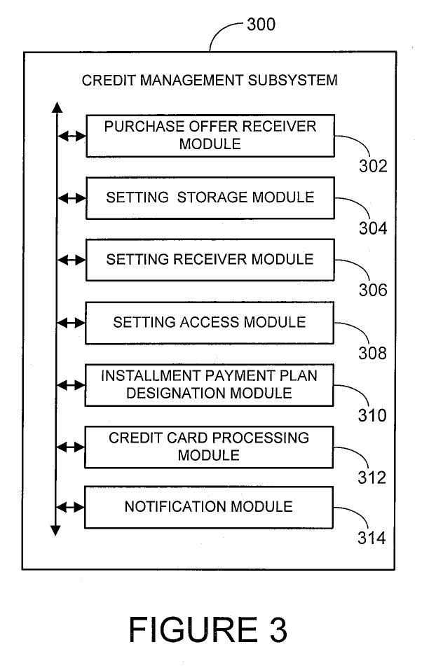

FIG. 3 illustrates an example credit management subsystem 300 that may be deployed in the processing machine 102 and/or the provider 106 of the system 100 as the credit management subsystem 110 (see FIG. 1) or otherwise deployed in another system. The credit management subsystem 300 may include a purchase offer receiver module 302, a setting receiver module 304, a setting storage module 306, a setting access module 308, an installment payment plan designation module 310, a credit card processing module 312, and/or a notification module 314. Other modules may also be included.

The purchase offer receiver module 302 receives a purchase offer for an item utilizing a credit card. The item may be a big ticket item (e.g., a big screen television) or a different kind of item. The purchase offer may be for a single item or multiple items. The credit card may be associated with a user.

The setting receiver module 304 receives a maximum period for payment and/or a maximum payment amount for payment. The setting storage module 306 stores the installment payment setting for the user based on the maximum payment amount and/or a maximum period for payment.

The setting access module 308 accesses an installment payment setting for the user. The installment payment plan designation module 310 designates a payment schedule and a payment amount for an installment payment plan based on the purchase offer and the installment payment setting. Designation of the payment schedule may be based on a maximum period for payment and/or a maximum payment amount. The payment schedule may be a fixed payment schedule or a variable payment schedule. The payment amount may be a fixed payment amount or a variable payment amount.

The credit card processing module 312 processes the credit card with the purchase offer responsive to the designating of the payment schedule and the payment amount. The notification module 314 notifies the user of the installment payment plan of an installment balance, a fixed payment schedule, and/or a fixed payment amount.

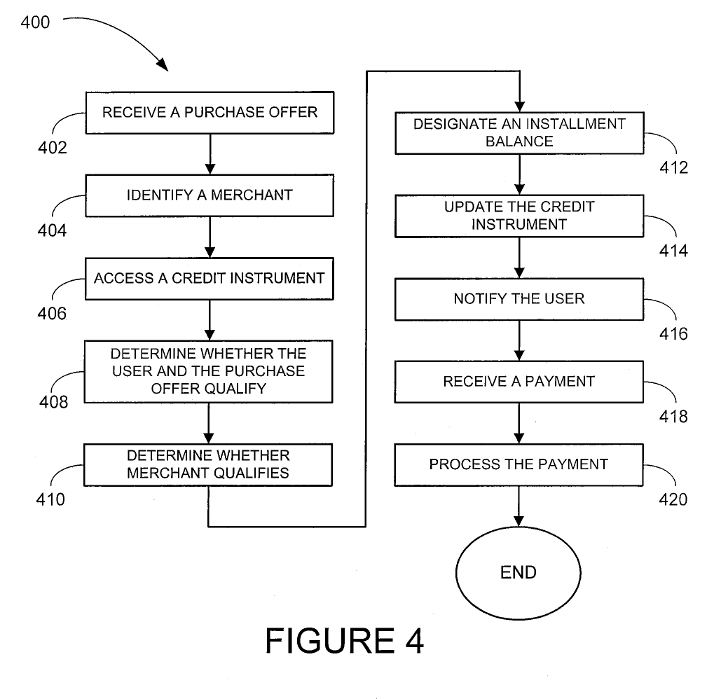

FIG. 4 illustrates a method 400 for credit instrument processing according to an example embodiment. The method 400 may be performed by the processing machine 102 and/or the provider 106 of the system 100 (see FIG. 1) or otherwise performed. In an example embodiment, the method 400 may be used to purchase a new item with an installment payment plan using a credit instrument based on one or more qualification.

A purchase offer for an item (e.g., a good or service) may be received at block 402. Identification of a merchant associated with the item may be made at block 404. The merchant may be an online retailer (e.g., BestBuy.com), an online buyer/seller platform (e.g., eBay.com), or a different type of merchant.

A credit instrument with a revolving balance is accessed at block 406. The credit instrument may be a credit card or a different type of credit instrument. The credit instrument may be associated with a user.

The revolving balance may reflect dollars, or different real currencies, virtual currencies, or other indications of value. The revolving balance of the credit instrument may be at a revolving balance interest rate. The revolving balance interest rate may be at a variable interest rate or a fixed interest rate.

A determination of whether the user and/or the purchase offer qualify for the installment payment plan may be made at block 408. For example, the cost of the item may have to be greater than a certain amount to qualify, the user may have to have a certain credit rating to qualify, and the like. A determination of whether the merchant qualifies for the installment payment plan may be made at block 410. The merchant may qualify by having a relationship with the provider of the credit instrument or may otherwise qualify.

An installment balance for the credit instrument is designated at block 412. The installment balance may be associated with a payment schedule and a payment amount. The payment schedule may be a fixed payment schedule or a variable payment schedule. The payment amount may be a fixed payment amount or a variable payment amount. The installment balance may be at a different interest rate than the revolving balance interest rate. The different interest rate may be at a fixed interest rate or a variable interest rate. The designation of the installment balance may be based on qualification of the user, the purchase offer and/or the merchant.

In an example embodiment, the designation of the installment balance/payment may be created with or without user input. For example, the offer may be a pre-determined offer with a pre-set time period and payment amount, the offer could ask the user for one or more inputs regarding time period or payment amount, or the like.

The credit instrument is updated responsive to the designation of the installment balance at block 414. For example, an update may reflect an installment balance, a changed total amount owed, or the like.

The user may be notified at block 416. The notification may be of the payment schedule, the payment amount (e.g., a monthly payment amount), and/or the installment payment plan. The notification may include an amount of the installment balance, a time to pay off the installment balance, and an interest rate for the installment payment plan.

A payment associated with the user may be received at block 418. At block 420, the payment may be processed based on the revolving balance and the installment balance.

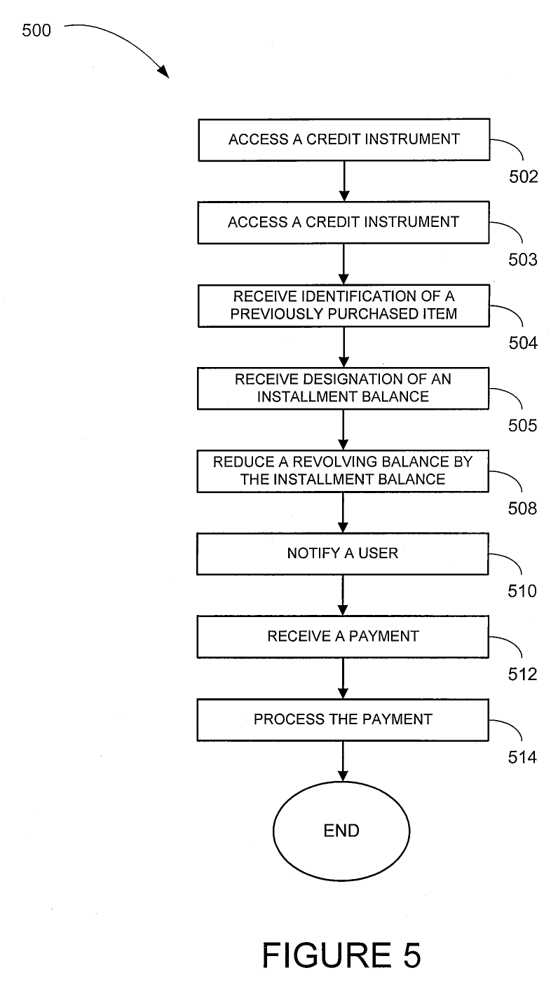

FIG. 5 illustrates a method 500 for credit instrument processing according to an example embodiment. The method 500 may be performed by the provider 106 of the system 100 (see FIG. 1) or otherwise performed. In an example embodiment, the method 500 may be used to convert a current balance (e.g., associated with one or more previously purchase items) on a credit instrument from counting against a revolving balance to being associated with an installment balance.

A credit instrument with a revolving balance is accessed at block 502. Identification of one or more previously purchased items may be received by the user at block 504. For example, a billing statement may be provided to the user. The user may then select an item on the billing statement for which an installment payment plan is sought.

An identification of a balance portion (e.g., a partial balance portion) may be received at block 505. The balance portion may be associated with the one or more or more previously purchased items or may be otherwise identified.

An installment balance for the credit instrument is designated at block 506. The installment balance may be associated with one or more previously purchased items and/or the balance portion.

The revolving balance may be reduced by the installment balance at block 508. By performing the operations at block 504 and block 508 or block 505 and block 508, a previously purchased item or a balance portion that was a part of a revolving balance of a credit instrument may instead be made as part of an installment balance of the credit instrument.

The user may be notified at block 510. The notification may be of the payment schedule, the payment amount, and/or the installment payment plan.

A payment associated with the user may be received at block 512. At block 514, the payment may be processed based on the revolving balance and the installment balance.

In an example embodiment, the method 500 may be continually used to enable a remaining amount due for purchased items to be paid off within a certain time period. For example, a user may choose an option to create a payment plan so that their entire balance is on schedule to be paid off within X months (e.g., one year). Then, every billing cycle, with the new balance that exists for that billing cycle, a payment may be calculated based an intended pay off of the new balance in twelve months.

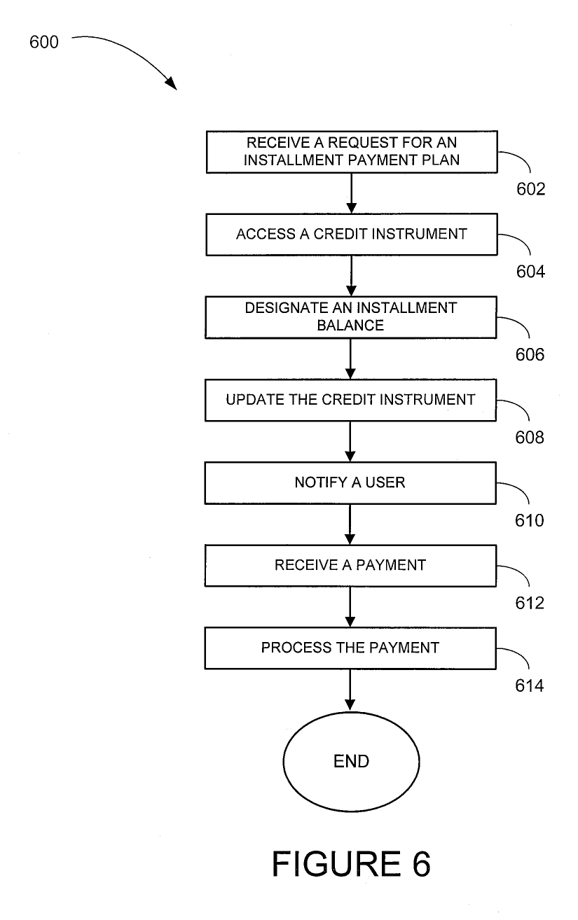

FIG. 6 illustrates a method 600 for credit instrument processing according to an example embodiment. The method 600 may be performed by the provider 106 of the system 100 (see FIG. 1) or otherwise performed. In an example embodiment, the method 600 may be used to purchase a new item with an installment payment plan using a credit instrument based on receipt of a request for the installment payment plan.

At block 602, a request for an installment payment plan with the payment schedule associated with the credit instrument and/or the payment amount associated with the credit instrument may be received. In an example embodiment, the request may include desired thresholds/parameters for the installment payment plan by the user. For example, the thresholds/parameters may include payment amount, time to pay off, monthly payment amount, interest rate, or the like.

A credit instrument with a revolving balance is accessed at block 604. An installment balance for the credit instrument is designated at block 606. The designation of the installment balance may be responsive to the receiving of the request for the installment payment plan.

The credit instrument is updated responsive to the designation of the installment balance at block 608. The user may be notified at block 610. The notification may be of the payment schedule, the payment amount, and/or the installment payment plan.

A payment associated with the user may be received at block 612. At block 614, the payment may be processed based on the revolving balance and the installment balance.

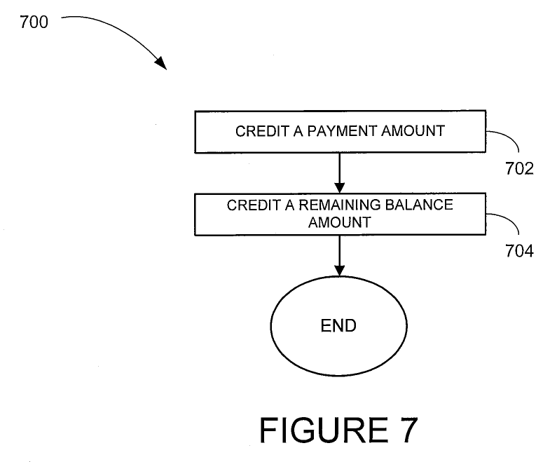

FIG. 7 illustrates a method 700 for payment processing according to an example embodiment. The method 700 may be performed at block 420, block 516, block 614 (see FIGS. 4-6) or otherwise performed.

A payment amount of the payment is credited to the installment balance at block 702. A remaining balance amount of the payment is credited to the revolving balance at block 704. The remaining balance amount may be credited after the payment amount is credited.

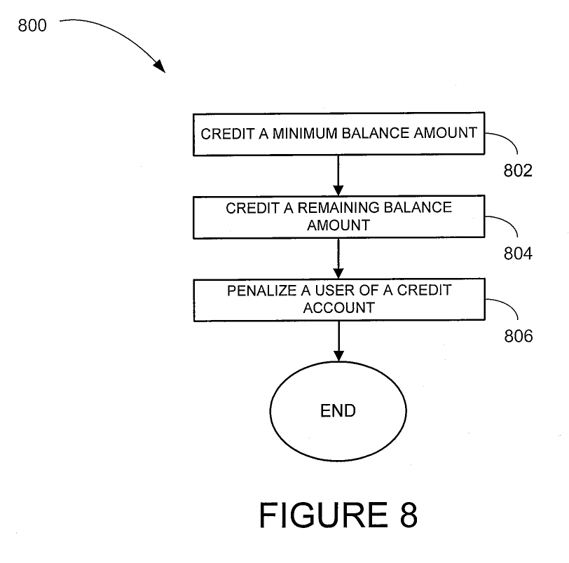

FIG. 8 illustrates a method 800 for payment processing according to an example embodiment. The method 800 may be performed at block 420, block 516, block 614 (see FIGS. 4-6) or otherwise performed.

A minimum balance amount of the payment may be credited to the revolving balance at block 802. In an example embodiment, the minimum balance amount may be a required payment by the provider 106 or the use will be subject to a penalty for the revolving balance.

A remaining balance amount of the payment may be credited to the installment balance at block 804. The remaining balance amount may be less than the fixed payment amount.

At block 806, the user of the credit account may be penalized based on the remaining balance amount being less than the fixed payment amount. The penalization may include adding a fee to the installment balance and altering the payment schedule and a fixed payment amount responsive to the adding of the fee. The penalization may include adding a fee to the installment balance and altering the payment amount of a next payment responsive to the adding of the fee. The penalization may include adding the installment balance to the revolving balance and eliminating the installment balance associated with the credit instrument. The decision to penalize and the type of penalty may be made based on a determination of a number of late payments made by the user.

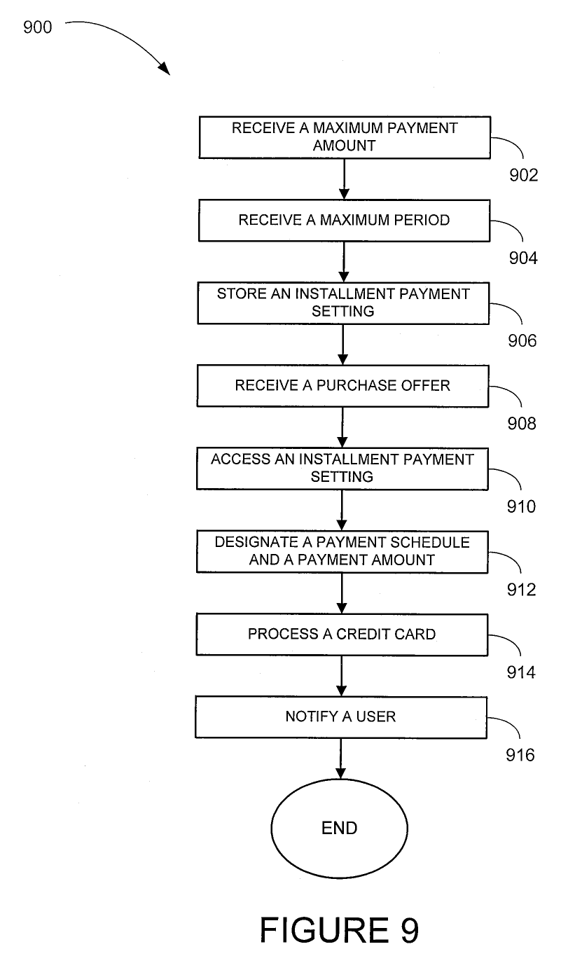

FIG. 9 illustrates a method 900 for credit card processing according to an example embodiment. The method 900 may be performed by the provider 106 of the system 100 (see FIG. 1) or otherwise performed.

A maximum payment amount for payment may be received at block 902. A maximum period for payment may be received at block 904. An installment payment setting for the user may be stored at block 906. The installment payment setting may be stored based on the maximum period for payment and/or the maximum payment amount. For example, a user may define a desired maximum payment amount per payment or a desired maximum period of payments for an installment payment plan.

A purchase offer for an item utilizing a credit card is received at block 908. The credit card may be associated with a user. The item may be a big ticket item or a different type of item.

An installment payment setting for the user is accessed at block 910. A payment schedule and a payment amount are designated for an installment payment plan based on the purchase offer and the installment payment setting at block 912. The payment schedule may be a variable payment schedule or a fixed payment schedule. The payment amount may be a variable payment schedule or is a fixed payment amount. The payment amount may be based on the maximum payment amount. The payment schedule may be based on the maximum period for payment.

At block 914, the credit card is processed with the purchase offer responsive to the designating of the payment schedule and the payment amount. The user may be notified at block 916. The notification provided to the user may be of an installment balance, the payment schedule, and/or the payment amount. The user may be otherwise notified.

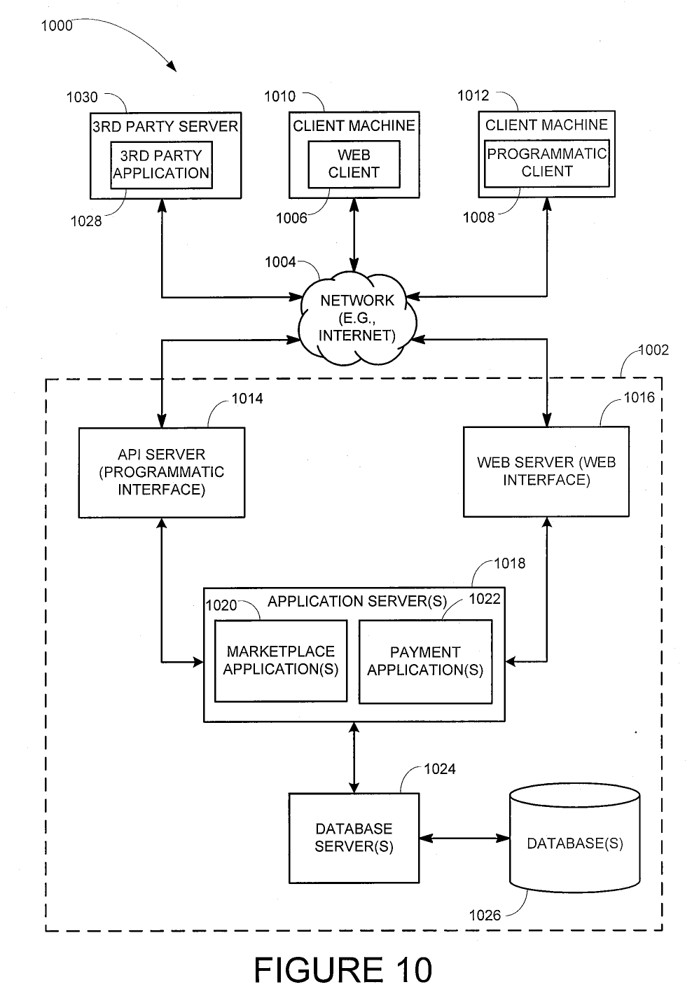

FIG. 10 is a network diagram depicting a client-server system 1000, within which one example embodiment may be deployed. By way of example, a network 1004 may include the functionality of the network 104, the provider 106 may be deployed within an application server 1018, and the processing machine 102 may include the functionality of a client machine 1010 or a client machine 1012. The system 100 may also be deployed in other systems.

A networked system 1002, in the example forms of a network-based marketplace or publication system, provides server-side functionality, via a network 1004 (e.g., the Internet or Wide Area Network (WAN)) to one or more clients. FIG. 10 illustrates, for example, a web client 1006 (e.g., a browser, such as the Internet Explorer browser developed by Microsoft Corporation of Redmond, Wash. State), and a programmatic client 1008 executing on respective client machines 1010 and 1012.

An Application Program Interface (API) server 1014 and a web server 1016 are coupled to, and provide programmatic and web interfaces respectively to, one or more application servers 1018. The application servers 1018 host one or more marketplace applications 1020 and authentication providers 1022. The application servers 1018 are, in turn, shown to be coupled to one or more databases servers 1024 that facilitate access to one or more databases 1026.

The marketplace applications 1020 may provide a number of marketplace functions and services to users that access the networked system 1002. The authentication providers 1022 may likewise provide a number of payment services and functions to users. The authentication providers 1022 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 1020. While the marketplace and authentication providers 1020 and 1022 are shown in FIG. 10 to both form part of the networked system 1002, in alternative embodiments the authentication providers 1022 may form part of a payment service that is separate and distinct from the networked system 1002.

Further, while the system 1000 shown in FIG. 10 employs a client-server architecture, the present invention is of course not limited to such an architecture, and could equally well find application in a distributed, or peer-to-peer, architecture system, for example. The various marketplace and authentication providers 1020 and 1022 could also be implemented as standalone software programs, which need not have networking capabilities.

The web client 1006 accesses the various marketplace and authentication providers 1020 and 1022 via the web interface supported by the web server 1016. Similarly, the programmatic client 1008 accesses the various services and functions provided by the marketplace and authentication providers 1020 and 1022 via the programmatic interface provided by the API server 1014. The programmatic client 1008 may, for example, be a seller application (e.g., the TurboLister™ application developed by eBay Inc., of San Jose, Calif.) to enable sellers to author and manage listings on the networked system 1002 in an off-line manner, and to perform batch-mode communications between the programmatic client 1008 and the networked system 1002.

FIG. 10 also illustrates a third party application 1028, executing on a third party server machine 1030, as having programmatic access to the networked system 1002 via the programmatic interface provided by the API server 1014. For example, the third party application 1028 may, utilizing information retrieved from the networked system 1002, support one or more features or functions on a website hosted by the third party. The third party may, for example, provide one or more promotional, marketplace or payment functions that are supported by the relevant applications of the networked system 1002.

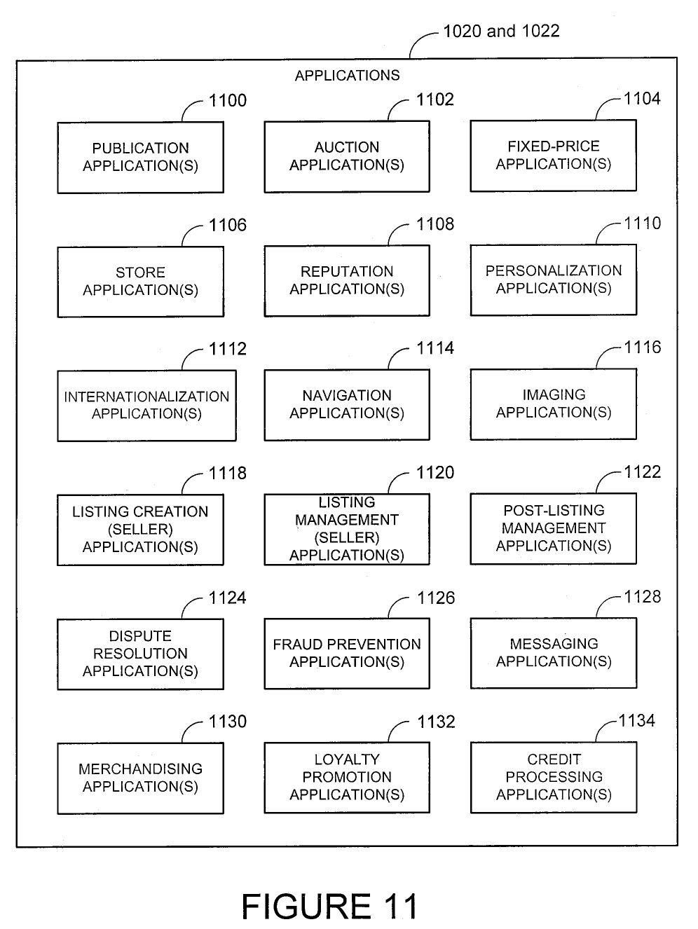

FIG. 11 is a block diagram illustrating multiple applications 1020 and 1022 that, in one example embodiment, are provided as part of the networked system 1002 (see FIG. 10). The applications 1020 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 1026 via the database servers 1024.

The networked system 1002 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 1020 are shown to include at least one publication application 1100 and one or more auction applications 1102 which support auction-format listing and price setting mechanisms (e.g., English, Dutch, Vickrey, Chinese, Double, Reverse auctions etc.). The various auction applications 1102 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 1104 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 1106 allow a seller to group listings within a “virtual” store, which may be branded and otherwise personalized by and for the seller. Such a virtual store may also offer promotions, incentives and features that are specific and personalized to a relevant seller.

Reputation applications 1108 allow users that transact, utilizing the networked system 1002, to establish, build and maintain reputations, which may be made available and published to potential trading partners. Consider that where, for example, the networked system 1002 supports person-to-person trading, users may otherwise have no history or other reference information whereby the trustworthiness and credibility of potential trading partners may be assessed. The reputation applications 1108 allow a user, for example through feedback provided by other transaction partners, to establish a reputation within the networked system 1002 over time. Other potential trading partners may then reference such a reputation for the purposes of assessing credibility and trustworthiness.

Personalization applications 1110 allow users of the networked system 1002 to personalize various aspects of their interactions with the networked system 1002. For example a user may, utilizing an appropriate personalization application 1110, create a personalized reference page at which information regarding transactions to which the user is (or has been) a party may be viewed. Further, a personalization application 1110 may enable a user to personalize listings and other aspects of their interactions with the networked system 1002 and other parties.

The networked system 1002 may support a number of marketplaces that are customized, for example, for specific geographic regions. A version of the networked system 1002 may be customized for the United Kingdom, whereas another version of the networked system 1002 may be customized for the United States. Each of these versions may operate as an independent marketplace, or may be customized (or internationalized and/or localized) presentations of a common underlying marketplace. The networked system 1002 may accordingly include a number of internationalization applications 1112 that customize information (and/or the presentation of information) by the networked system 1002 according to predetermined criteria (e.g., geographic, demographic or marketplace criteria). For example, the internationalization applications 1112 may be used to support the customization of information for a number of regional websites that are operated by the networked system 1002 and that are accessible via respective web servers 1016.

Navigation of the networked system 1002 may be facilitated by one or more navigation applications 1114. For example, a search application (as an example of a navigation application) may enable key word searches of listings published via the networked system 1002. A browse application may allow users to browse various category, catalogue, or system inventory structures according to which listings may be classified within the networked system 1002. Various other navigation applications may be provided to supplement the search and browsing applications.

In order to make listings available via the networked system 1002 as visually informing and attractive as possible, the marketplace applications 1020 may include one or more imaging applications 1116 utilizing which users may upload images for inclusion within listings. An imaging application 1116 also operates to incorporate images within viewed listings. The imaging applications 1116 may also support one or more promotional features, such as image galleries that are presented to potential buyers. For example, sellers may pay an additional fee to have an image included within a gallery of images for promoted items.

Listing creation applications 1118 allow sellers conveniently to author listings pertaining to goods or services that they wish to transact via the networked system 1002, and listing management applications 1100 allow sellers to manage such listings. Specifically, where a particular seller has authored and/or published a large number of listings, the management of such listings may present a challenge. The listing management applications 1100 provide a number of features (e.g., auto-relisting, inventory level monitors, etc.) to assist the seller in managing such listings. One or more post-listing management applications 1102 also assist sellers with a number of activities that typically occur post-listing. For example, upon completion of an auction facilitated by one or more auction applications 1002, a seller may wish to leave feedback regarding a particular buyer. To this end, a post-listing management application 1102 may provide an interface to one or more reputation applications 1108, so as to allow the seller conveniently to provide feedback regarding multiple buyers to the reputation applications 1108.

Dispute resolution applications 1114 provide mechanisms whereby disputes arising between transacting parties may be resolved. For example, the dispute resolution applications 1114 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention applications 1126 implement fraud detection and prevention mechanisms to reduce the occurrence of fraud within the networked system 1002.

Messaging applications 1128 are responsible for the generation and delivery of messages to users of the networked system 1002, such messages for example advising users regarding the status of listings at the networked system 1002 (e.g., providing “outbid” notices to bidders during an auction process or to provide promotional and merchandising information to users). Respective messaging applications 1128 may utilize any one have a number of message delivery networks and platforms to deliver messages to users. For example, messaging applications 1128 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1130 support various merchandising functions that are made available to sellers to enable sellers to increase sales via the networked system 1002. The merchandising applications 1130 also operate the various merchandising features that may be invoked by sellers, and may monitor and track the success of merchandising strategies employed by sellers.

The networked system 1002 itself, or one or more parties that transact via the networked system 1002, may operate loyalty programs that are supported by one or more loyalty/promotions applications 1132. For example, a buyer may earn loyalty or promotions points for each transaction established and/or concluded with a particular seller, and may be offered a reward for which accumulated loyalty points can be redeemed.

A credit processing application 1134 may enable a user to be provided with credit for the purchase of items. The loan processing application 1134 may be provided a user with a credit instrument (e.g., a credit card) on which the user may purchase items. The purchased items may be subject to a revolving balance and/or an installment balance.

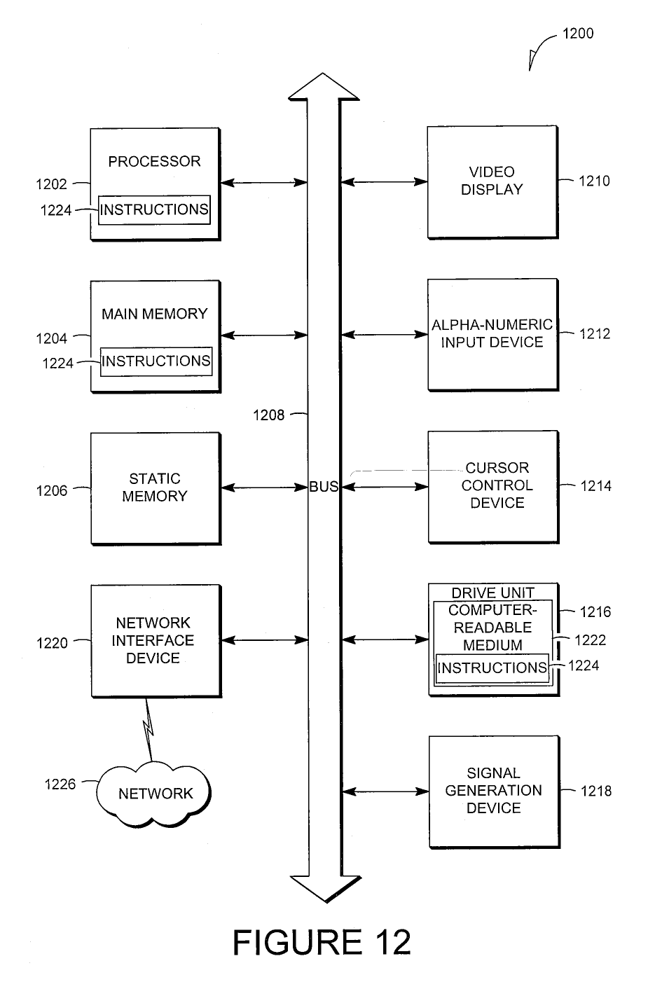

FIG. 12 shows a diagrammatic representation of machine in the example form of a computer system 1200 within which a set of instructions may be executed causing the machine to perform any one or more of the methods, processes, operations, or methodologies discussed herein. The provider 106 may operate on or more computer systems 1200. The processing machine 102 may include the functionality of one or more computer systems 1200.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU) a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a drive unit 1216, a signal generation device 1218 (e.g., a speaker) and a network interface device 1220.

The drive unit 1216 includes a machine-readable medium 1222 on which is stored one or more sets of instructions (e.g., software 1224) embodying any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media.

The software 1224 may further be transmitted or received over a network 1226 via the network interface device 1220.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for installment payment utilization have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a credit instrument with a revolving balance, the credit instrument being associated with a user, the revolving balance at a revolving balance interest rate;
designating an installment balance for the credit instrument, the installment balance associated with a payment schedule and a payment amount and being at a different interest rate than the revolving balance interest rate; and
updating the credit instrument responsive to designation of the installment balance.

2. The method of claim 1, further comprising:
receiving a purchase offer for an item; and
determining whether the user and the purchase offer qualify for an installment payment plan,
wherein the designation of the installment balance is based on qualification of the user and the purchase offer.

3. The method of claim 2, further comprising:
receiving identification of a merchant associated with the item; and
determining whether the merchant qualifies for the installment payment plan,
wherein the designation of the installment balance is based on qualification of the user, the purchase offer and the merchant.

4. The method of claim 1, wherein the updating of the credit instrument comprises:
reducing the revolving balance by the installment balance,
wherein the designating of the installment balance is responsive to the reducing of the revolving balance.

5. The method of claim 4, further comprising:
receiving an identification of a previously purchased item by the user, the installment balance being associated with the previously purchase item,
wherein the reducing of the revolving balance is responsive to the receiving of the identification.

6. The method of claim 4, further comprising:
receiving identification of a balance portion by the user, the installment balance being associated with the balance portion,
wherein the reducing of the revolving balance is responsive to the receiving of the designation of the balance portion.

7. The method of claim 1, further comprising:
receiving a payment associated with the user; and
processing the payment based on the revolving balance and the installment balance.

8. The method of claim 7, wherein the processing of the payment comprises:
crediting a payment amount of the payment to the installment balance; and
crediting a remaining balance amount of the payment to the revolving balance.

9. The method of claim 7, wherein the processing of the payment comprises:
crediting a minimum balance amount of the payment to the revolving balance;
crediting a remaining balance amount of the payment to the installment balance, the remaining balance amount being less than the fixed payment amount; and
penalizing the user of the credit account based on the remaining balance amount being less than the fixed payment amount.

10. The method of claim 9, wherein the penalizing comprises:
adding a fee to the installment balance; and
altering the payment schedule and a fixed payment amount responsive to the adding of the fee.

11. The method of claim 9, wherein the penalizing comprises:
adding a fee to the installment balance; and
altering the payment amount of a next payment responsive to the adding of the fee.

12. The method of claim 9, wherein the penalizing comprises:
adding the installment balance to the revolving balance; and
eliminating the installment balance associated with the credit instrument.

13. The method of claim 12, further comprising:
determining a number of late payments made by the user,
wherein the adding of the installment balance to the revolving balance is responsive to the determining the number of late payments.

14. The method of claim 1, further comprising:
receiving a request for an installment payment plan with the payment schedule associated with the credit instrument,
wherein the designating of the installment balance is responsive to the receiving of the request.

15. The method of claim 1, further comprising:
receiving a request for an installment payment plan with the payment amount associated with the credit instrument,
wherein the designating of the installment balance is responsive to the receiving of the request.

16. The method of claim 1, wherein the credit instrument is a credit card.

17. The method of claim 1, wherein the payment schedule is a fixed payment schedule and a payment amount is a fixed payment amount.

18. The method of claim 1, wherein the revolving balance interest rate is at a variable interest rate and the different interest rate is at a fixed interest rate.

19. A method comprising:
receiving a purchase offer for an item utilizing a credit card, the credit card associated with a user;
accessing an installment payment setting for the user;
designating a payment schedule and a payment amount for an installment payment plan based on the purchase offer and the installment payment setting; and
processing the credit card with the purchase offer responsive to the designating of the payment schedule and the payment amount.

20. The method of claim 19, further comprising:
notifying the user of the installment payment plan of at least one of an installment balance, the fixed payment schedule, the fixed payment amount, or combinations thereof.

21. The method of claim 19, further comprising:
receiving a maximum period for payment; and
storing the installment payment setting for the user based on the maximum period for payment,
wherein the payment schedule is based on the maximum period for payment.

22. The method of claim 19, further comprising:
receiving a maximum payment amount for payment; and
storing the installment payment setting for the user based on the maximum payment amount,
wherein the payment amount is based on the maximum payment amount.

23. The method of claim 19, wherein the payment schedule is a fixed payment schedule and a payment amount is a fixed payment amount.

24. A machine-readable medium comprising instructions, which when implemented by one or more processors perform the following operations:
access a credit instrument with a revolving balance, the credit instrument being associated with a user, the revolving balance at a revolving balance interest rate;
designate an installment balance for the credit instrument, the installment balance associated with a payment schedule and a payment amount and being at a different interest rate than the revolving balance interest rate; and
update the credit instrument responsive to designation of the installment balance.

25. The machine-readable medium of claim 24 further comprising instructions, which when implemented by one or more processors perform the following operations:
receive a payment associated with the user; and
process the payment based on the revolving balance and the installment balance.

26. A machine-readable medium comprising instructions, which when implemented by one or more processors perform the following operations:
receive a purchase offer for an item utilizing a credit card, the credit card associated with a user;
access an installment payment setting for the user;
designate a payment schedule and a payment amount for an installment payment plan based on the purchase offer and the installment payment setting; and
process the credit card with the purchase offer responsive to the designating of the payment schedule and the payment amount.

27. The machine-readable medium of claim 26 further comprising instructions, which when implemented by one or more processors perform the following operations:
receive a maximum payment amount for payment; and
store the installment payment setting for the user based on the maximum payment amount,
wherein the payment amount is based on the maximum payment amount.

28. A system comprising:
a credit instrument access module accesses a credit instrument with a revolving balance, the credit instrument being associated with a user, the revolving balance being at a revolving balance interest rate;
an installment balance designation module designates an installment balance for the credit instrument accessed by the credit instrument access module, the installment balance associated with a payment schedule and a payment amount and being at a different interest rate than the revolving balance interest rate; and
a credit instrument updating module updates the credit instrument accessed by the credit instrument access module responsive to designation of the installment balance.

29. The system of claim 28, further comprising:
a revolving balance reduction module reduces the revolving balance accessed by the revolving balance access module by the installment balance,
wherein designation of the installment balance by the installment balance designation module is responsive to a reduction of the revolving balance by the revolving balance reduction module.

30. The system of claim 28, further comprising:
a payment receiver module receives a payment associated with the user; and
a payment processing module processes the payment received by the payment receiver module based on the revolving balance accessed by the revolving balance access module and the installment balance designated by the installment balance designation module.
